(19) United States
(12) Patent Application Publication
(10) Pub. No.: US 2018/0156530 A1
(43) Pub. Date: Jun. 7, 2018

(54) Home Appliance Device and Method for Assembling a Home Appliance Device

(71) Applicant: BSH HAUSGERAETE GMBH, Muenchen (DE)

(72) Inventors: YASIN AKMAN, TEKIRDAG (TR); ZIYA ARSLANKIRAY, TEKIRDAG (TR); MEHMET CIYANOGLU, ISTANBUL (TR); AYDIN SAHIN, ISTANBUL (TR)

(21) Appl. No.: 15/366,173

(22) Filed: Dec. 1, 2016

(51) Int. Cl. F25D 23/02; F25D 11/00; E05D 11/00

(52) U.S. Cl. CPC F25D 23/028; F25D 11/00; E05Y 2900/31; F25D 2323/024; E05D 11/00

(57) ABSTRACT

For the purpose of improving stability a home appliance device, in particular a home chiller appliance device, is proposed. The device includes at least one supporting element for supporting at least one hinge unit by bearing against a home appliance housing, the supporting element has at least one first fastening portion for fastening the supporting element to the hinge unit and at least one second fastening portion for fastening the supporting element to the home appliance housing.

### BACKGROUND OF THE INVENTION

### Field of the Invention

The invention relates to a home appliance device, in particular a home chiller appliance device and a method for assembling a home appliance device.

### SUMMARY OF THE INVENTION

An objective of the invention is, in particular, to provide a home appliance device with improved characteristics regarding stability. This objective is achieved, according to the claimed invention. Further implementations and further developments of the invention may be gathered from the dependent claims.

A home appliance device, in particular a home chiller appliance device, is proposed, comprising: at least one supporting element for supporting at least one hinge unit by bearing against a home appliance housing, the supporting element comprising at least one first fastening portion for fastening the supporting element to the hinge unit and at least one second fastening portion for fastening the supporting element to the home appliance housing.

By means of the invention, in particular stability of the home appliance device can be improved. Thus, in particular a fatigue strength and/or a durability of the home appliance device may be advantageously increased. Moreover, in particular, a lowering of the hinge unit may be counteracted. In addition, a loading capacity, in particular of a home appliance door, may be improved significantly. Furthermore, an efficiency, in particular a manufacturing efficiency, an installation space efficiency and/or a cost efficiency, can be advantageously improved.

By a “home appliance device” is in particular to be understood at least a part and/or a portion, in particular a sub-assembly group, of a home appliance. The home appliance is in particular provided for storing and preferably tempering victuals such as beverages, meat, fish, vegetables, fruits, milk and/or dairy products in at least one operating state, in particular for the purpose of enhancing a quality and/or a keepability of the stored victuals. For this purpose, the home appliance device may in particular comprise at least one home appliance housing which in particular defines at least one storage space and/or at least one home appliance door, which is in particular configured for closing and preferably sealing off the storage space. In addition, the home appliance device may in particular comprise the hinge unit. For example, the home appliance is embodied as a home chiller appliance, which is in at least one operating state configured for cooling victuals. The home chiller appliance could in particular be embodied as a climate cabinet, an ice-box, a refrigerator, a freezer, a refrigerator-freezer combination and/or a wine cooler. However, the home appliance could also be embodied as a home appliance for warming and in particular for cooking victuals, e.g. an oven, a steamer and/or a microwave. In this context, “configured” is in particular to mean specifically programmed, designed and/or equipped. By an object being configured for a certain function is in particular to be understood that the object implements and/or fulfills said certain function in at least one application state and/or operating state.

Moreover, a “supporting element” is, in particular, to be understood as an element which may in particular be implemented separately from the home appliance housing, the home appliance door and/or the hinge unit and which may in particular be configured to strengthen the hinge unit and/or to increase a mechanical stability of the hinge unit, in particular against a weight force of the home appliance door. In particular, the supporting element may be configured for at least partly and in particular at least largely absorbing a weight of the hinge unit and in particular the home appliance door and/or for at least partly and in particular at least largely transferring a weight of the hinge unit and in particular the home appliance door to the home appliance housing. In particular, in a mounted state the supporting element may encompass an edge of the home appliance housing, in particular an edge which connects a front wall of the home appliance housing with a side wall, in particular a lateral side wall, of the home appliance housing. In particular, in the mounted state the supporting element may be located in an upper area and/or in a bottom area of the home appliance housing and/or of the home appliance door. The term “at least largely” is to mean, in particular, at least 55%, advantageously at least 65%, preferably at least 75%, more preferably at least 85% and particularly advantageously at least 95%.

Furthermore, a “hinge unit” may in particular to be understood as a unit being configured for movably connecting the home appliance door to the home appliance housing. For this purpose, the hinge unit in particular may comprise at least one hinge, in particular a door hinge and in particular an integrated door hinge. In particular, in the mounted state the hinge unit may be located in an upper area and/or in a bottom area of the home appliance housing and/or of the home appliance door.

In addition, it is proposed that the supporting element may be configured to prevent a lowering of the hinge unit and by that in particular a lowering of the home appliance door. In this way, in particular, a fatigue strength and/or a durability may be improved such that a persistent closing efficiency and/or a persistent cooling efficiency may be obtained.

Furthermore, it is proposed that the first fastening portion and the second fastening portion may be located at different sides of the home appliance housing in the mounted state. In this way, in particular, a high stability and/or rigidity may be created easily. In particular, the first fastening portion and the second fastening portion may be located at least substantially perpendicular to each other. In this context, “at least substantially perpendicular” is in particular to mean an orientation of a direction with respect to a reference direction, in particular in a plane, wherein the direction and the reference direction include an angle of 90°, the orientation in particular having a deviation of less than 15°, advantageously of less than 10° and particularly advantageously of less than 2°.

The first fastening portion may be configured for connecting the supporting element to the hinge unit in an adhesively-bonded and/or cohesively-bonded manner. However, in particular, for the purpose of improving maintenance, it is proposed that the first fastening portion may be configured for detachably connecting the supporting element to the hinge unit, in particular in a form-fit and/or force-fit manner and in particular at least partly by at least one snap-fit connection and/or in particular by at least one screw connection. The supporting element may be connected or fastened directly or indirectly to the hinge unit via the first fastening unit. In particular the first fastening unit may be configured for fastening the supporting element to a hinge support unit which is configured for being connected to the hinge unit.

In addition, the second fastening portion may be configured for connecting the supporting element to the home appliance housing in an adhesively-bonded and/or cohesively-bonded manner. However, in particular, for the purpose of improving an assembly process and/or a stability, it is proposed that the second fastening portion may be configured for detachably connecting the supporting element to the home appliance housing, in particular in a form-fit and/or force-fit manner and in particular at least partly by at least one snap-fit connection and/or in particular by at least one screw connection. The second fastening portion may be configured for fastening the supporting element directly or indirectly to the home appliance housing. According to an embodiment of the invention the supporting element may be fastened directly, in particular by at least one screw connection, to the home appliance housing and may be fastened indirectly to the hinge unit, in particular may be fastened directly to a hinge support unit by at least one screw connection. This allows a simple and yet stable connection between the hinge, the supporting element and the home appliance housing.

The supporting element may be implemented in multiple parts. However, in particular it is proposed that the supporting element may be implemented integrally. “Implemented integrally” is in particular to mean, in this context, connected at least by substance-to-substance bond, e.g. by a welding process, an adhesive bonding, an injection-molding process and/or by another process that is deemed expedient by a person having ordinary skill in the art. In particular, “implemented integrally” could in particular mean made of one piece. “Made of one piece” is, in particular, to mean, in this context, manufactured from one single piece, e.g. by production from one single cast and/or by manufacturing in a one-component or multi-component injection-molding process, and for example from a single blank. In this way, in particular, costs may be reduced advantageously. Moreover, a stability and/or rigidity of the supporting element may be improved further.

The supporting element may be implemented at least partly, at least largely and/or completely of plastic and/or of a composite material. However, for the purpose of increasing a fatigue strength and/or a durability, it is proposed that the supporting element may be implemented at least partly, in particular at least largely and in particular completely, of metal, in particular aluminum and/or in particular steel, for example high-grade steel and/or stainless steel.

The supporting element may be made of a flat piece. For example a thickness may be 50 times smaller or 30 times smaller or 20 times smaller than a largest extension of the supporting element. This allows to embody a comparatively small supporting element which in particular can be integrated into existing designs of home appliance devices. The supporting element may be a stamped-bent metal piece. The supporting element may be bent along at least one edge. In this way the supporting element may surround one edge of the home appliance device thus enabling a compact design and a strong connection to the home appliance housing while at the same time increasing a structural rigidity of the supporting element. The supporting element may bent along at least two or several edges. In this way additionally the supporting element may be integrated well into a given geometry of the hinge and/or of a hinge support unit. The edge and/or the edges may be oriented vertically in an assembled state, thus allowing the supporting element to surround a vertical edge of the home appliance housing. In particular the supporting element may be bent along three edges.

According to another embodiment of the invention, it is proposed that the supporting element may be implemented at least substantially mirror-symmetrically, in particular such that the supporting element may be applied to both sides, in particular both lateral side walls, of the home appliance housing. The term “at least substantially mirror-symmetrically” is to be understood in particular as mirror-symmetrically apart from manufacturing tolerances and/or within the limits of standardized tolerances and/or within the limits of manufacturing possibilities. In this way, in particular, a particularly flexible home appliance device may be obtained. Moreover, an opening direction of the home appliance door can be changed easily.

Additionally, it is proposed that the hinge unit may comprise at least one hinge, in particular the aforementioned hinge, and at least one hinge support unit for supporting the hinge. In this context, a “hinge support unit” is, in particular, to be understood as a unit which may in particular be implemented separately from the home appliance housing, the home appliance door, the hinge and/or the supporting element and which may in particular be configured to adapt and/or to connect the hinge to the home appliance housing and/or the supporting element. In particular, the hinge support unit may be configured for at least partly and/or at least largely absorbing a weight of the hinge and in particular the home appliance door and/or for at least partly and/or at least largely transferring a weight of the hinge and in particular of the home appliance door to the home appliance housing. The hinge support unit may be implemented integrally and/or in particular in multiple parts. Moreover, the hinge support unit may be implemented at least partly, at least largely and/or completely of plastic, of a composite material and/or of metal, in particular aluminum and/or steel, in particular high-grade steel and/or stainless steel. A fatigue strength and/or a durability can be improved if all elements of the hinge support unit may be of metal. In particular, the supporting element and the hinge support unit may form a reinforcement unit for supporting the hinge and/or for mounting the hinge to the home appliance housing. In this way, in particular, a particularly flexible home appliance device may be obtained. The reinforcement unit may be configured to be assembled as a pre-assembly unit. A “pre-assembly unit” may in particular be a unit which after all elements of the pre-assembly unit are fixed or attached to each other can be mounted to and removed from the door and/or the home appliance housing as a single unit. In particular a worker can handle this unit without the risk or possibility of one of the elements being lost or unintentionally displaced with respect to each other during handling. In particular, the elements of the pre-assembly unit may be fixed or attached to each other yielding in a “mounted state” of these elements with respect to each other, and this mounted state will not change once the pre-assembly unit is mounted to the door and/or to the home appliance housing. This may simplify the assembly process and/or may increase the accuracy. The hinge support unit may be configured for attaching the door the home appliance housing with or without the supporting element. In particular the assembly process of the door to the home appliance housing may not be different in case no supporting element is used, except that the connection of the supporting element to the home appliance housing is not necessary. This improves a design and/or manufacturing flexibility since the same type of door and/or home appliance housing and/or hinge support unit may be used with or without a supporting element.

In particular, for improving an assembling process and/or for increasing an ease of use, it is proposed that the first fastening portion may be configured for connecting the supporting element, in particular directly, to the hinge support unit.

Further, the invention relates to a method for assembling a home appliance device, in particular a home chiller appliance device, the home appliance device comprising: at least one supporting element for supporting at least one hinge unit by bearing against a home appliance housing, the supporting element comprising at least one first fastening portion for fastening the supporting element to the hinge unit and at least one second fastening portion for fastening the supporting element to the home appliance housing, wherein the supporting element is fastened to the hinge unit in one step and fastened to the home appliance housing in one further step.

In this way, in particular stability of the home appliance device can be improved. Thus, in particular a fatigue strength and/or a durability of the home appliance device may be advantageously increased. Moreover, in particular a lowering of the hinge unit may be counteracted. In addition, a loading capacity in particular of a home appliance door may be improved significantly. Furthermore, an efficiency, in particular a manufacturing efficiency, an installation space efficiency and/or a cost efficiency, can be advantageously improved.

Herein, the home appliance device and the method for assembling the home appliance device are not to be limited to the application and implementation described above. In particular, for the purpose of fulfilling a functionality herein described, the home appliance device and the method for assembling the home appliance device may comprise a number of respective elements, structural components and units that differ from the number mentioned herein.

Furthermore, regarding the value ranges mentioned in this disclosure, values within the limits mentioned are to be understood to be also disclosed and to be used as applicable.

Further advantages may become apparent from the following description of the drawing. In the drawing an exemplary embodiment of the invention is shown. The drawing, the description and the claims contain a plurality of features in combination. The person having ordinary skill in the art will purposefully also consider the features separately and will find further expedient combinations.

### BRIEF DESCRIPTION OF THE SEVERAL VIEWS OF THE DRAWING

FIG. 1 a home appliance comprising a home appliance device with a hinge unit and a supporting element, in a schematic front view,

FIG. 2 the supporting element and the hinge unit, in a detailed view,

FIG. 3a-b the supporting element and the hinge unit, in sectional views,

FIG. 4 the supporting element and the hinge unit, in an unassembled view,

FIG. 5 the supporting element and the hinge unit, in a partly exploded view,

FIG. 6 the supporting element and a hinge support unit of the hinge unit, in a perspective view,

FIG. 7a-b the supporting element and the hinge support unit, in exploded views,

FIG. 8a-b the supporting element, in different perspective views and

FIG. 9 a flow chart of a method for assembling the home appliance device.

### DETAILED DESCRIPTION OF THE INVENTION

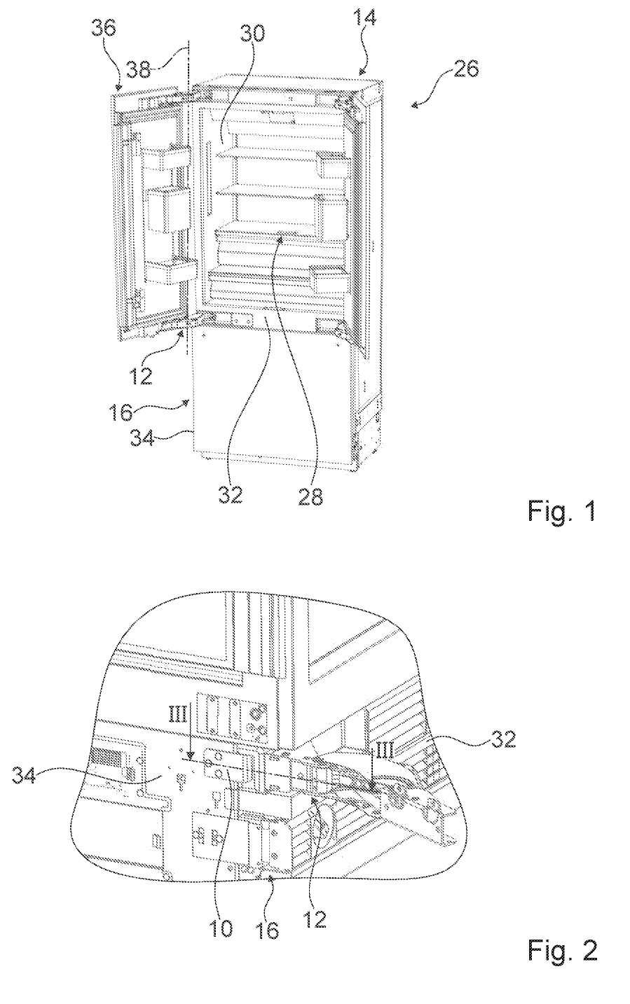

FIG. 1 shows a perspective view of an exemplary home appliance 26 comprising a home appliance device. In the present case, the home appliance 26 is implemented as a home chiller appliance, in particular as a refrigerator-freezer combination. Alternatively, a home appliance could be embodied as any other kind of home chiller appliance, like a refrigerator, a freezer and/or a wine-cooler. In addition, a home appliance could also be embodied as a home appliance for warming and in particular for cooking victuals, e.g. an oven, a steamer and/or a microwave.

The home appliance 26 is configured for cooling victuals. For this purpose, the home appliance device comprises a home appliance housing 14. The home appliance housing 14 defines a storage space 28, in particular for storing and tempering the victuals. The home appliance housing 14 comprises an inner liner 30, in particular defining the storage space 28, and several side walls, in particular at least a front wall 32 and a lateral side wall 34 forming an edge 16 of the home appliance housing 14.

The home appliance device further comprises at least one home appliance door 36. The home appliance door 36 is movably connected to the home appliance housing 14. In the present case, the home appliance door 36 is pivotally connected to the home appliance housing 14. The home appliance door 36 is pivotable about a pivot axis 38 which is perpendicular to a base, a ground and/or a floor space of the home appliance 26. In a closed state, the home appliance door 36 closes off the home appliance housing 14, in particular the storage space 28, at least partly. For completely closing off and in particular sealing off the storage space 28, the home appliance device comprises a further home appliance door, which for reasons of clarity and comprehensibility no reference number is given to. Alternatively, a home appliance door could be pivotable about a pivot axis which is parallel to a base, a ground and/or a floor space of a home appliance. Moreover, a home appliance door may be connected to a home appliance housing in a linearly movable manner and/or in a push-pull manner. In addition, it is conceivable that a home appliance device may comprise exactly one home appliance door.

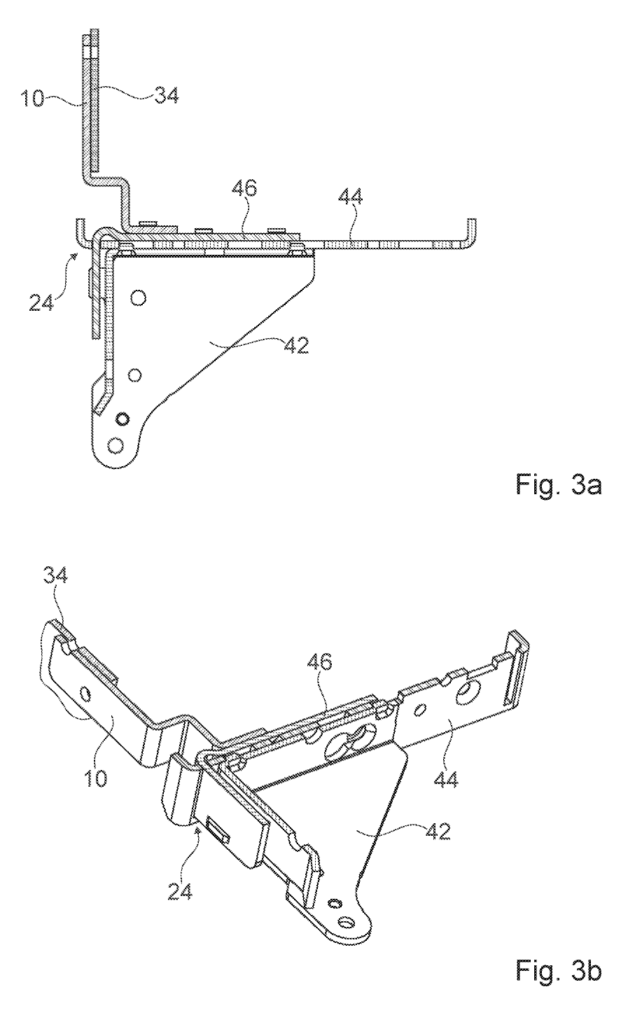

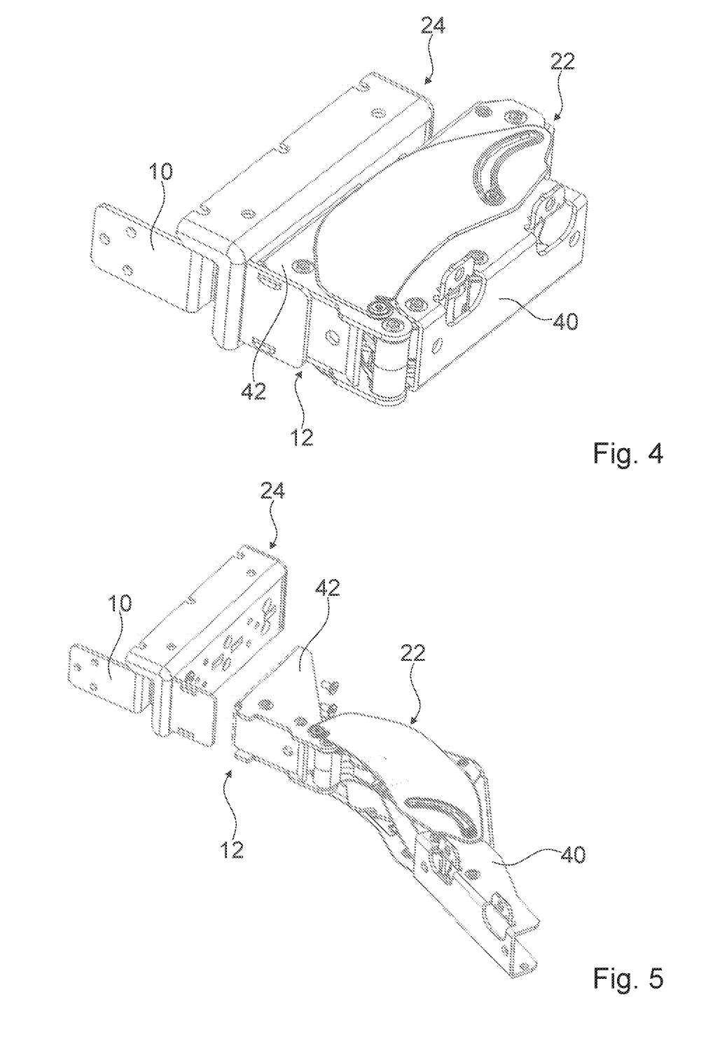

Moreover, the home appliance device comprises at least one hinge unit 12 (see also FIGS. 2 to 5). The hinge unit 12 is located in a bottom area of the home appliance door 36. The hinge unit 12 is located in a close vicinity of the edge 16. The hinge unit 12 is located in a lower corner of the home appliance door 36. The hinge unit 12 is fastened to the home appliance housing 14. Moreover, the hinge unit 12 is fastened to the home appliance door 36. The hinge unit 12 is configured for movably connecting the home appliance door 36 with the home appliance housing 14. For completely supporting the home appliance door 36, the home appliance device comprises a further hinge unit, which is located in an upper corner of the home appliance door 36 and which for reasons of clarity and comprehensibility no reference number is given to.

The hinge unit 12 comprises a hinge 22 and a hinge support unit 24. The hinge 22 is implemented as a door hinge, in the present case in particular an integrated door hinge known in the art. The hinge 22 comprises a first hinge mount 40 and a second hinge mount 42.

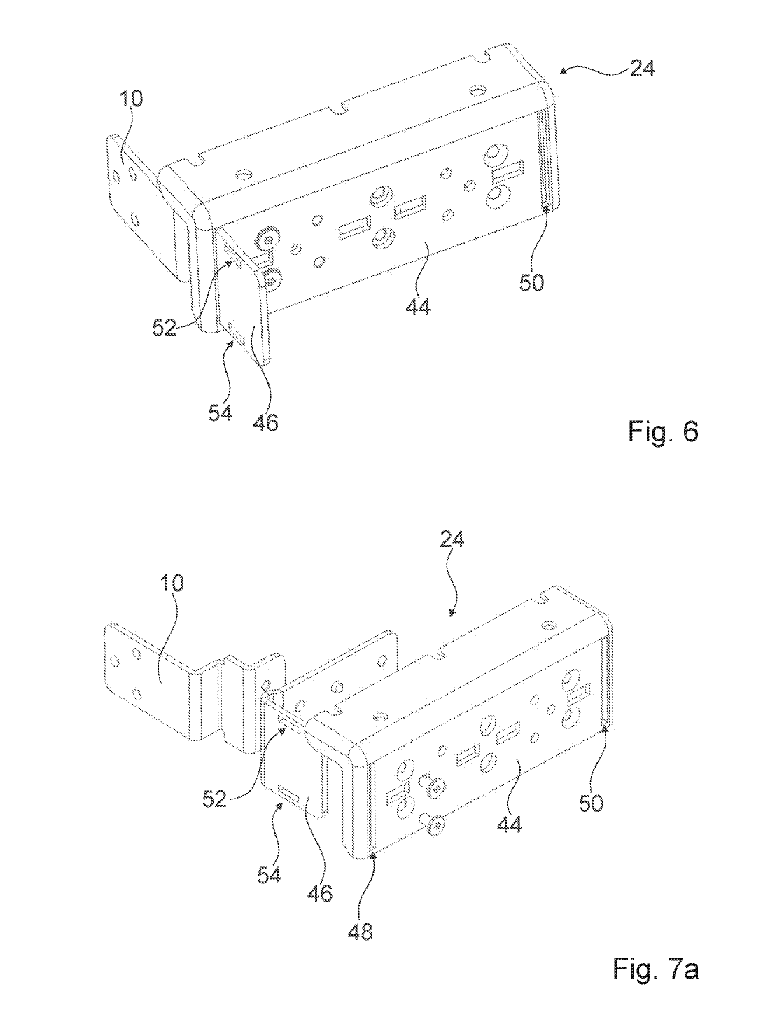

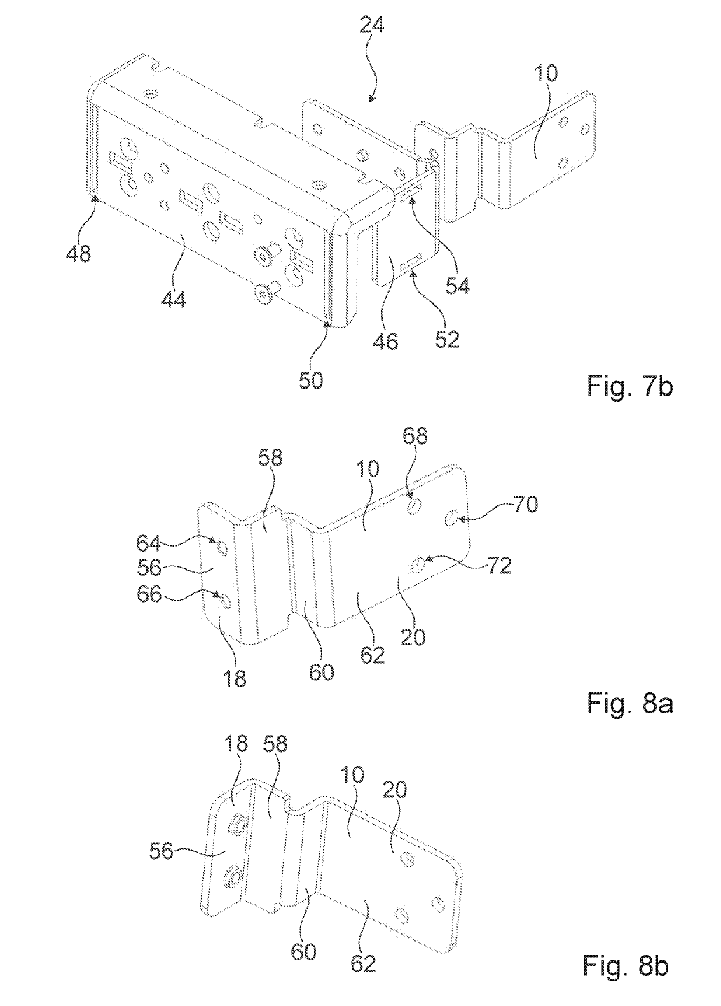

The hinge support unit 24 is implemented separately from the hinge 22. The hinge support unit 24 is implemented in multiple parts. The hinge support unit 24 comprises two hinge support elements 44, 46, in particular a first hinge support element 44 and a second hinge support element 46 (see also FIGS. 6 to 7b).

The first hinge support element 44 defines a main part and/or a mainly outer part of the hinge support unit 24. The first hinge support element 44 is implemented integrally. The first hinge support element 44 is implemented of metal, in the present case in particular steel. The first hinge support element 44 is at least substantially L-shaped. The first hinge support element 44 is implemented mirror-symmetrically. The first hinge support element 44 comprises at least one receiving opening 48, 50 for a pass-through of the second hinge support element 46. In the present case, the first hinge support element 44 comprises two receiving openings 48, 50 for an alternative pass-through of the second hinge support element 46, in particular such that the hinge support unit 24 may be applied to both sides of the home appliance housing 14 (see in particular FIGS. 7a and 7b).

The second hinge support element 46 defines a further part and/or a mainly inner part of the hinge support unit 24. The second hinge support element 46 is implemented integrally. The second hinge support element 46 is implemented of metal, in the present case in particular steel. The second hinge support element 46 is at least substantially L-shaped. The second hinge support element 46 is implemented mirror-symmetrically. The second hinge support element 46 comprises at least one further receiving opening 52, 54 for a pass-through of the hinge 22 and in particular of the second hinge mount 42. In the present case, the second hinge support element 46 comprises two further receiving openings 52, 54 for a pass-through of the hinge 22 and in particular of the second hinge mount 42.

In an assembled state, the second hinge support element 46 passes through one of the receiving openings 48, 50 of the first hinge support element 44, in particular depending on an opening direction of the home appliance door 36.

Moreover, the second hinge support element 46 is fastened, more preferably screwed, to the first hinge support element 44.

In the present case, the hinge support unit 24 is configured to connect the hinge 22 to the home appliance housing 14 and to at least largely absorb a weight of the hinge 22 and the home appliance door 36.

In a mounted state, the first hinge mount 40 is fastened, preferably screwed, to the home appliance door 36. Moreover, in the mounted state, the second hinge mount 42 is fastened, preferably screwed, to the hinge support unit 24, in particular to the first hinge support element 44. Herein, the second hinge mount 42 passes through the further receiving openings 52, 54 of the second hinge support element 46. In addition, in the mounted state, the hinge support unit 24, in particular the first hinge support element 44, is fastened, preferably screwed, to the home appliance housing 14. Alternatively, it is conceivable to refrain from using a hinge support unit and/or to fasten, preferably screw, a hinge directly to a home appliance housing. Moreover, a snap-fit connection and/or rivets may be used to connect a hinge and/or a hinge unit to another object. In addition, a hinge support unit may be implemented integrally and/or in at least three parts.

In the mounted state, the hinge unit 12, in particular the hinge 22 and the hinge support unit 24, is/are configured to at least largely absorb a weight of the home appliance door 36.

However, in the aforementioned configuration the hinge unit 12 may lower over time due to the weight of the home appliance door 36.

Therefore, the home appliance device comprises at least one supporting element 10 (see in particular FIGS. 8a and 8b). The supporting element 10 is implemented separately from the hinge unit 12. The supporting element 10 is implemented integrally. The supporting element 10 is implemented of metal, in the present case in particular of steel. The supporting element 10 is implemented mirror-symmetrically in particular such that the supporting element 10 may be applied to both sides of the home appliance housing 14. For this purpose, the supporting element 10 and in particular the second hinge support element 46 are turned by 180°.

In the present case, the supporting element 10 comprises four, in particular at least substantially planar, supporting sections 56, 58, 60, 62, in particular a first supporting section 56, a second supporting section 58, a third supporting section 60 and a fourth supporting section 62. The first supporting section 56 and the second supporting section 58 are directly connected to each other. The first supporting section 56 and the second supporting section 58 are located perpendicular to each other. The third supporting section 60 is directly connected to the second supporting section 58. The third supporting section 60 is located perpendicular to the second supporting section 58. Moreover, the third supporting section 60 is located parallel to the first supporting section 56. The fourth supporting section 62 is directly connected to the third supporting section 60. The fourth supporting section 62 is located perpendicular to the third supporting section 60. Moreover, the fourth supporting section 62 is located parallel to the second supporting section 58. In addition, the fourth supporting section 62 is located perpendicular to the first supporting section 56.

The supporting element 10 is configured for supporting the hinge unit 12 by bearing against the home appliance housing 14 and by that in particular to strengthen the hinge unit 12 against the weight of the home appliance door 36. Thus, the supporting element 10 is configured to prevent a lowering of the hinge unit 12.

For this purpose, the supporting element 10 comprises a first fastening portion 18. The first fastening portion 18 is defined by the first supporting section 56. The first fastening portion 18 is configured for fastening the supporting element 10 to the hinge unit 12, in the present case in particular the hinge support unit 24. The first fastening portion 18 is configured for detachably connecting the supporting element 10 to the hinge unit 12. For this purpose, the first fastening portion 18 comprises at least one, in the present case in particular two connection elements 64, 66, in the present case in particular screw holes.

Moreover, the supporting element 10 comprises a second fastening portion 20. The second fastening portion 20 is defined by the fourth supporting section 62. Thus, the second fastening portion 20 is located perpendicular to the first fastening portion 18. The second fastening portion 20 comprises an area portion which exceeds an area portion of the first fastening portion 18 by at least 10%, preferably by at least 20% and more preferably by at least 30%. The second fastening portion 20 is configured for fastening the supporting element 10 to the home appliance housing 14, in the present case in particular the lateral side wall 34. The second fastening portion 20 is configured for detachably connecting the supporting element 10 to the home appliance housing 14. For this purpose, the second fastening portion 20 comprises at least one, in the present case in particular three further connection elements 68, 70, 72, in the present case in particular screw holes. Alternatively, a number of connection elements and/or further connection elements may differ. In addition, the hinge support unit may be implemented integrally with the supporting element.

In the mounted state, the supporting element 10 encompasses the edge 16 of the home appliance housing 14. In the mounted state, the first fastening portion 18 is fastened, in particular screwed, to the hinge unit 12, in the present case in particular the to hinge support unit 24 and more precisely to the second hinge support element 46. Moreover, in the mounted state, the second fastening portion 20 is fastened, in particular screwed, to the home appliance housing 14, in the present case in particular to the lateral side wall 34. Herein, the first fastening portion 18 and the second fastening portion 20 are located at different sides of the home appliance housing 14.

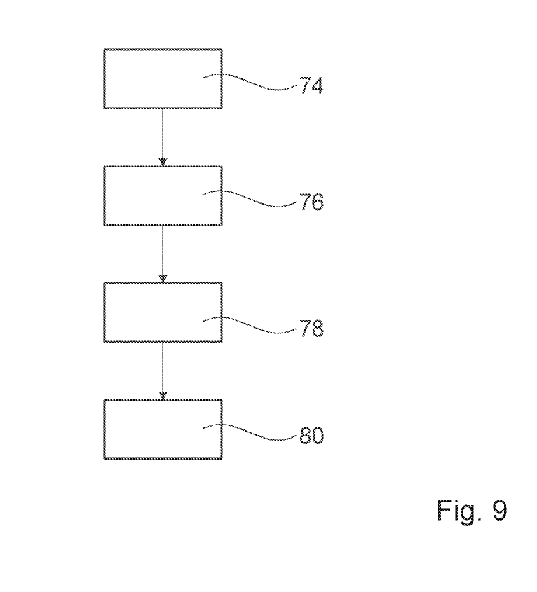

A method for assembling the home appliance device is shown in FIG. 9 and comprises the following steps:

In a first step 74, the hinge support unit 24 and the supporting element 10 are pre-assembled to each other to form a pre-assembly unit. Herein, the second hinge support element 46 is first inserted in one of the receiving openings 48, 50 of the first hinge support element 44. Afterwards, the supporting element 10, the first hinge support element 44 and the second hinge support element 46 are fastened to each other, in particular by using screws which are screwed in the connection elements 64, 66 of the first fastening portion 18.

In a second step 76, the hinge 22 is mounted to the hinge support unit 24. Herein, the hinge 22 is inserted in the further receiving openings 52, 54 of the second hinge support element 46 and afterwards screwed to the first hinge support element 44.

In a third step 78, the supporting element 10 and the hinge unit 12 are mounted to the home appliance housing 14. Herein, the supporting element 10 is fastened to the home appliance housing 14, in particular the lateral side wall 34, in particular by using screws which are screwed in the further connection elements 68, 70, 72 of the second fastening portion 20. Moreover, the hinge unit 12 is fastened to the home appliance housing 14, in particular to the front wall 32, in particular by using screws.

In a fourth step 80, the home appliance door 36 is mounted to the hinge unit 12. Herein, the home appliance door 36 is fastened to the hinge unit 12, in particular to the first hinge mount 40, in particular by using screws. However, alternatively it is conceivable to refrain from fastening a hinge unit to a home appliance housing and/or merely clamping a hinge unit in a receiving opening of a home appliance housing.

The following is a summary list of reference numerals and the corresponding structure used in the above description of the invention:
10 supporting element
12 hinge unit
14 home appliance housing
16 edge
18 fastening portion
20 fastening portion
22 hinge
24 hinge support unit
26 home appliance
28 storage space
30 inner liner
32 front wall
34 lateral side wall
36 home appliance door
38 pivot axis
40 hinge mount
42 hinge mount
44 hinge support element
46 hinge support element
48 receiving opening
50 receiving opening
52 receiving opening
54 receiving opening
56 supporting section
58 supporting section
60 supporting section
62 supporting section
64 connection element
66 connection element
68 connection element
70 connection element
72 connection element
74 step
76 step
78 step
80 step

1. A home appliance device, in particular a home chiller appliance device, comprising: at least one supporting element for supporting at least one hinge unit by bearing against a home appliance housing, the supporting element comprising at least one first fastening portion for fastening the supporting element to the hinge unit and at least one second fastening portion for fastening the supporting element to the home appliance housing.

2. The home appliance device according to claim 1, the supporting element being configured to prevent a lowering of the hinge unit.

3. The home appliance device according to claim 1, the first fastening portion and the second fastening portion are located at different sides of the home appliance housing in the mounted state.

4. The home appliance device according to claim 1, the first fastening portion being configured for detachably connecting the supporting element to the hinge unit.

5. The home appliance device according to claim 1, the second fastening portion being configured for detachably connecting the supporting element to the home appliance housing.

6. The home appliance device according to claim 1, the supporting element being implemented integrally.

7. The home appliance device according to claim 1, the supporting element being implemented at least partly of metal.

8. The home appliance device according to claim 1, the supporting element being implemented at least substantially mirror-symmetrically.

9. The home appliance device according to claim 1, the hinge unit comprising at least one hinge and at least one hinge support unit for supporting the hinge.

10. The home appliance device according to claim 9, the first fastening portion being configured for connecting the supporting element to the hinge support unit.

11. A home appliance, in particular a home chiller appliance, comprising at least one home appliance device according to claim 1.

12. A method for assembling a home appliance device, the home appliance device comprising: at least one supporting element for supporting at least one hinge unit by bearing against a home appliance housing, the supporting element comprising at least one first fastening portion for fastening the supporting element to the hinge unit and at least one second fastening portion for fastening the supporting element to the home appliance housing, wherein the supporting element is fastened to the hinge unit in one step and fastened to the home appliance housing in one further step.

13. The method according to claim 12, configured for assembly a home appliance device according to claim 1.
